(19) United States
(12) Patent Application Publication
(10) Pub. No.: US 2026/0043587 A1
(43) Pub. Date: Feb. 12, 2026

(54) CIRCUIT INCLUDING SUPERCAPACITOR FOR SUPPLYING POWER TO LEAK DETECTION CIRCUITRY AND CONTROLLER IN WATER HEATER

(71) Applicant: Ademco Inc., Golden Valley, MN (US)

(72) Inventor: Hyunki Kim, Rogers, MN (US)

(73) Assignee: Ademco Inc., Golden Valley, MN (US)

(21) Appl. No.: 18/998,346

(22) PCT Filed: Jul. 28, 2023
(86) PCT No.: PCT/US2023/071242

§ 371 Date: Jan. 24, 2025

Related U.S. Application Data
(60) Provisional application No. 63/369,713, filed on Jul. 28, 2022.

(51) Int. Cl. F24H 15/407; F24H 15/12; F24H 15/395; H02J 7/34

(52) U.S. Cl. CPC F24H 15/407; F24H 15/12; F24H 15/395; H02J 7/342; H02J 7/345; F24H 2240/01; H02J 2207/20

(57) ABSTRACT

A water heater pilot control system includes a supercapacitor; a battery; a controller configured to control ignition of a flame; and voltage control circuitry. The voltage control circuitry includes a first power converter configured to convert a voltage from one or both of the supercapacilor and the battery to a predetermined voltage; a second power converter configured to convert a voltage from a thermoelectric device to the predetermined voltage; and charging circuitry configured to charge the supercapacitor using the predetermined voltage from one or both of the first power converter and the second power converter, wherein one or both of the first power converter and the second power converter are configured to supply the predetermined voltage to the controller.

### CROSS REFERENCE TO RELATED APPLICATION

This application claims the benefit of, and priority to, U.S. Provisional Patent Application No. 63/369,713 filed Jul. 28, 2022, its entirety of which is incorporated herein by reference.

### TECHNICAL FIELD

The disclosure relates to water heating systems

### BACKGROUND

Tank-type water heating systems which incorporate gas combustion as a heat source typically utilize a pilot flame issuing from a pilot burner to initiate combustion of a main gas flow. Some systems have traditionally utilized a continuous pilot which remains lit during all operations, regardless of whether main burner operation is occurring.

### SUMMARY

In general, the disclosure is directed to techniques for a water heater system that utilizes a first power converter to set generate a predetermined voltage level from one or both of a supercapacitor and a pre-charged power source, and a second power converter to generate the predetermined voltage level from a thermoelectric device. One or both of the first power converter and the second power converter can supply the predetermined voltage to a controller configured to control ignition of a flame for heating water. As described in more detail below, having a first converter and second converter that supply substantially the same voltage to the controller may improve the system by allowing the thermoelectric device and/or the supercapacitor to supply voltage to the controller via first and second the power converters while preserving a charge of the pre-charged power source. For example, the second power converter may supply predetermined voltage that is simultaneously delivered to the controller and to charging circuitry for charging the supercapacitor. This may allow the supercapacitor to have enough stored charge to supply the controller with the predetermined voltage via the first power converter when the second power converter does not receive voltage from the thermoelectric device.

The supercapacitor, pre-charged power source, and one or both of the first and second power converters may supply power to one or more elements of a system. For example, the system may include a controller that is configured to control whether a pilot flame is ignited or extinguished. The system may, in some cases, be a pilot control system for a water heater. Leak detection circuitry may detect whether the water heater has a leak, and activate an alarm when the circuitry detects a leak. In some examples, the pilot control system may include a thermoelectric device that is configured to be placed proximate to the pilot flame such that the thermoelectric device is configured to generate an electric signal when the pilot flame is ignited. In some examples, the system may include a chargeable power source such as a supercapacitor that the system charges using the electric signal from the thermoelectric device. The system may additionally or alternatively include a pre-charged power source (e.g., a battery) that is configured to power one or more elements of the system.

In some cases, it may be beneficial for the system to extend a longevity of the pre-charged power source by using the thermoelectric device to charge one or more circuit elements such as the controller and/or the leak detection circuitry. The system may include one or more power converters that convert power supplied by the supercapacitor and/or the pre-charged power source. For example, a first power converter may convert a voltage from one or both of the supercapacitor and the pre-charged power source to a predetermined voltage. A second power converter may convert a voltage from the thermoelectric device to the predetermined voltage. The second power converter may, in some examples, charge the supercapacitor. Charging the supercapacitor may help to extend a longevity of the pre-charged power source as compared with pilot control systems that do not charge a power source using an electrical signal generated by a thermoelectric device. When heat energy from a pilot flame is converted to electrical energy to power circuit components, a smaller amount of energy is drawn from the pre-charged power source as compared with systems that do not charge a supercapacitor using an electric signal from a thermoelectric device. By having separate power converters, recharging the supercapacitor while powering the controller may be achieved efficiently.

In one example, a water heater pilot control system includes a supercapacitor; a battery; a controller configured to control ignition of a flame; and voltage control circuitry. The voltage control circuitry includes a first power converter configured to convert a voltage from one or both of the supercapacitor and the battery to a predetermined voltage; a second power converter configured to convert a voltage from a thermoelectric device to the predetermined voltage; and charging circuitry configured to charge the supercapacitor using the predetermined voltage from one or both of the first power converter and the second power converter, wherein one or both of the first power converter and the second power converter are configured to supply the predetermined voltage to the controller.

In another example, a method includes controlling, by a controller, ignition of a flame; converting, by a first power converter of voltage control circuitry, a voltage from one or both of the supercapacitor and the battery to a predetermined voltage; and converting, by a second power converter of the voltage control circuitry, a voltage from a thermoelectric device to the predetermined voltage. Additionally, the method includes charging, by charging circuitry of the voltage control circuitry, the supercapacitor using the predetermined voltage from one or both of the first power converter and the second power converter; and supplying, by one or both of the first power converter and the second power converter, the predetermined voltage to the controller.

In another example, a circuit includes a first power converter configured to convert a voltage from one or both of a supercapacitor and a pre-charged power source to a predetermined voltage; a second power converter configured to convert a voltage from a thermoelectric device to the predetermined voltage; and a charging circuit configured to charge the supercapacitor using the predetermined voltage from one or both of the first power converter and the second power converter, wherein one or both of the first power converter and the second power converter are configured to supply the predetermined voltage to a controller.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram illustrating a water heater control system, in accordance with one or more techniques of this disclosure.

FIG. 2 is a block diagram illustrating a water heater control system including a first one or more circuit elements, in accordance with one or more techniques of this disclosure.

FIG. 3 is a block diagram illustrating a water heater control system including a second one or more circuit elements, in accordance with one or more techniques of this disclosure.

FIG. 4 provides an example water heater system including an intermittent pilot light and a main burner, in accordance with one or more techniques of this disclosure.

FIG. 5 is a flow diagram illustrating an example operation for delivering electrical energy to a supercapacitor and a controller, in accordance with one or more techniques of this disclosure.

### DETAILED DESCRIPTION

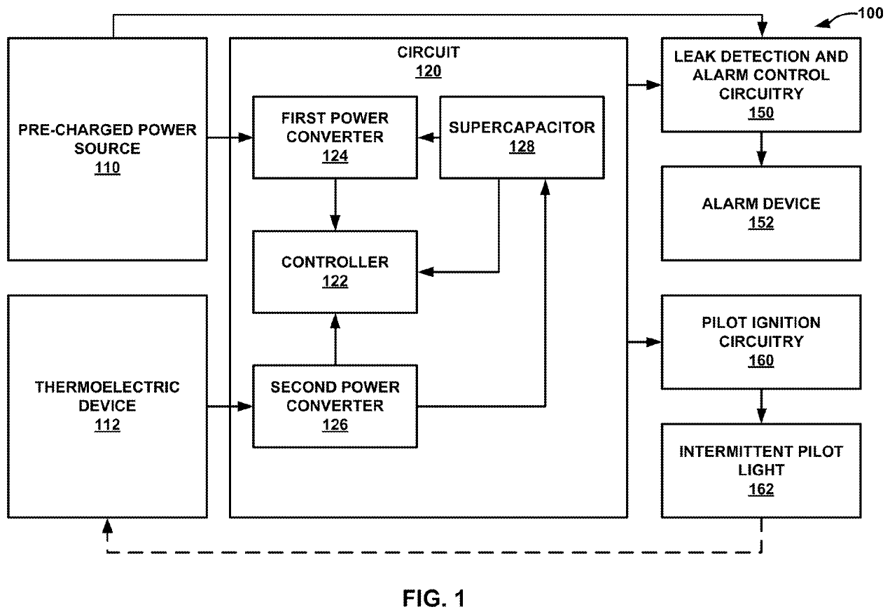

FIG. 1 is a block diagram illustrating a water heater control system 100, in accordance with one or more techniques of this disclosure. As seen in FIG. 1, water heater control system 100 includes pre-charged power source 110, thermoelectric device 112, circuit 120, leak detection and alarm control circuitry 150, alarm device 152, pilot ignition circuitry 160, and intermittent pilot light 162. Circuit 120 includes controller 122, first power converter 124, second power converter 126, and supercapacitor 128. Circuit 120 may perform one or more functions that require a supply of electrical energy. Circuit 120 may receive electrical energy from pre-charged power source 110 and thermoelectric device 112. It may be beneficial in some cases for circuit 120 to draw electrical energy from thermoelectric device 112 as opposed to drawing electrical energy from pre-charged power source 110 so that a level of charge of pre-charged power source 110 is preserved.

Pre-charged power source 110 is configured to deliver electrical energy to circuit 120. In some examples, pre-charged power source 110 includes a battery and circuitry for delivering power from the battery to circuit 120. In some examples, pre-charged power source 110 has a level of charge that decreases when pre-charged power source delivers electrical energy to circuit 120. In some examples, pre-charged power source 110 is rechargeable to allow extended operation. Pre-charged power source 110 may include any one or more of a plurality of different battery types, such as nickel cadmium batteries and lithium-ion batteries. In some examples, pre-charged power source 110 may include one or more consumer batteries (e.g., AA batteries, AAA batteries).

Thermoelectric device 112 is an electrical circuit component that is configured to convert thermal energy into electrical energy (e.g., a thermopile). In some examples, thermoelectric device 112 generates an output voltage that is proportional to a local temperature difference or temperature gradient. For example, thermoelectric device 112 may include two or more different metals that generate the output voltage based on the thermoelectric effect. In some examples, thermoelectric device 112 is located proximate to intermittent pilot light 162 such that when intermittent pilot light 162 is ignited, thermoelectric device 112 converts heat energy from intermittent pilot light 162 into electrical energy for delivery to circuit 120.

Controller 122, in some examples, may include one or more processors (e.g., processing circuitry) that are configured to implement functionality and/or process instructions for execution within water heater control system 100. For example, controller 122 may be capable of processing instructions stored in a memory. Controller 122 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, controller 122 may include any suitable structure, whether in hardware, software, firmware, or any combination thereof, to perform the functions ascribed herein to controller 122.

Controller 122 may be configured to control one or more functions of water heater control system 100. For example, controller 122 may control pilot ignition circuitry 160 to ignite and/or extinguish intermittent pilot light 162. Additionally, or alternatively, controller 122 may control whether a main burner (not illustrated in FIG. 1) is ignited or extinguished. Controller 122 may draw energy from one or more power sources in order to perform functions. In some examples, controller 122 may receive energy from pre-charged power source 110 via first power converter 124. In some examples, controller 122 may receive energy from thermoelectric device 112 via second power converter 126. In some examples, controller 122 may receive energy from supercapacitor 128 via first power converter 124.

In some cases, first power converter 124 includes a DC-to-DC power converter configured to regulate electrical signal received from pre-charged power source 110 and/or supercapacitor 128. In some examples, first power converter 124 represents a boost converter that increases a voltage of a received electrical signal and decreases a current of a received electrical signal. First power converter 124 is not limited to being a boost converter. In some examples, first power converter 124 may include a buck converter, a buck-boost converter, or another kind of power converter. In some examples, first power converter 124 may regulate an output electrical signal such that the electrical signal output from first power converter holds a steady voltage. In some examples, the output electrical signal from first power converter 124 is approximately 3V, but this is not required. The output electrical signal from first power converter 124 may include any voltage.

In some cases, second power converter 126 includes a DC-to-DC power converter configured to regulate electrical signal received from thermoelectric device 112. In some examples, second power converter 125 represents a boost converter that increases a voltage of a received electrical signal and decreases a current of a received electrical signal. In some examples, second power converter 126 may regulate an output electrical signal such that the electrical signal output from first power converter holds a steady voltage. In some examples, the output electrical signal from second power converter 126 is approximately 3V, but this is not required. The output electrical signal from second power converter 126 may include any voltage.

In some examples, a voltage output from the first power converter 124 and a voltage from the second power converter 126 is substantially the same. First power converter 124 and a second power converter 126 may, in some examples, output voltage to the same node. This means that a voltage at the node may be the same when first power converter 124 outputs voltage to the node as compared to when the second power converter 126 outputs voltage to the node. In some examples, controller 122 may be connected to the node. Controller 122 may receive substantially the same voltage when first power converter 124 supplies voltage to the node as compared with when second power converter 126 supplies voltage to the node. In some examples, both of first power converter 124 and second power converter 126 both supply substantially the same voltage to the node at the same time. Controller 122 may receive substantially the same voltage in cases where only first power converter 124 supplies voltage to the node, in cases where only second power converter 126 supplies voltage to the node, and in cases where both first power converter 124 and second power converter 126 supply voltage to the node. In some examples, the node connected to the controller 122, the first power converter 124, the second power converter 126 may be referred to herein as a “common bus.” The terms “node” and “common bus” may refer to a part of the circuit that occupies the same voltage at any given time, such that circuitry connected to the node or the common bus receives the voltage of the node or common bus.

Supercapacitor 128 may include a capacitor that is capable of charging when receiving energy and discharging when delivering energy. For example, when supercapacitor 128 receives an output electrical signal from second power converter 126, supercapacitor 128 may charge. When supercapacitor 128 delivers an output electrical signal, supercapacitor 128 may discharge, releasing at least some stored energy that is built up as supercapacitor 128 charges. In some examples, supercapacitor 128 may charge using energy received from thermoelectric device 112 via second power converter 126 so that supercapacitor 128 does not draw energy from pre-charged power source 110.

In some examples, supercapacitor 128 may charge when supercapacitor 128 receives an output voltage from second power converter 126. Second power converter 126 may generate the output voltage based on receiving an input voltage from thermoelectric device 112. This means that supercapacitor 128 may charge using energy that is derived from thermoelectric device 112. In some examples, when second power converter 126 delivers the output voltage to supercapacitor 128 to charge supercapacitor 128, second power converter 126 may also deliver the output voltage to controller 122. Controller 122 may perform one or more operations based on receiving the output voltage from second power converter 126 when second power converter 126 receives electrical energy from thermoelectric device 112 when intermittent pilot light 162 is activated.

In some cases, when intermittent pilot light 162 is deactivated and thermoelectric device does not deliver electrical energy to second power converter 126, supercapacitor 128 may deliver electrical energy to first power converter 124. First power converter 124 may convert the electrical energy received from supercapacitor 128 into an output voltage and deliver this output voltage to controller 122, allowing controller 122 to perform one or more operations. This means that even when second power converter 126 does not deliver an output voltage to controller 122 because intermittent pilot light 162 is not activated, controller 122 may draw power from supercapacitor 128 without drawing power from pre-charged power source 110 and decreasing the level of charge of pre-charged power source.

When a voltage of supercapacitor 128 falls below a threshold voltage, and when intermittent pilot light 162 is deactivated, first power converter 124 may, in some cases, convert electrical energy received from pre-charged power source 110 into the output voltage for delivery to controller 122. Controller 122 may additionally or alternatively control pilot ignition circuitry 160 to ignite intermittent pilot light 162 when the voltage of supercapacitor 128 falls below a threshold voltage so that controller 122 can receive energy that is derived from thermoelectric device 112 without drawing power from pre-charged power source 110.

Controller 122 may, in some examples, continuously operate by receiving one or more electrical signals at a predetermined voltage. In some cases, it may be beneficial for controller 122 to draw energy derived from thermoelectric device 112 rather than drawing energy derived from pre-charged power source 110 to decrease a rate at which the charge of pre-charged power source 110 depletes. By drawing energy from thermoelectric device 112 and/or supercapacitor 128, which is charged using energy from thermoelectric device 112, controller 122 may increase a longevity of pre-charged power source 110 as compared with systems that do not power one or more controllers using electrical energy derived from a thermoelectric device.

Leak detection and alarm control circuitry 150 may include circuitry configured to detect a liquid leak in a water heater and generate an alarm signal based on detecting a leak. In some examples, leak detection and alarm control circuitry 150 may include a leak sensor. The leak sensor may include one or more conductive elements that are configured to generate an electrical signal in response to sensing a leak in the water heater device. For example, if moisture accumulates on the conductive elements of the leak sensor, a magnitude of a parameter (e.g., current magnitude or voltage magnitude) of the electrical signal produced by the leak sensor may change (e.g., increase or decrease) from a first parameter value to a second parameter value. Leak detection and alarm control circuitry 150 may be configured to detect such a change in the electrical signal generated by the leak sensor and output, based on the change in the electrical signal an alarm signal indicating that a leak is occurring in the water heater.

Leak detection and alarm control circuitry 150 may output an alarm signal to alarm device 152 in response to detecting a leak in the water heater. In some examples, the alarm signal may include cause alarm device 152 to activate. Alarm device 152 may, in some examples, include a piezoelectric device. Alarm device 152 may emit an audio signal when activated, but this is not required. In some examples, alarm device 152 may include a silent alarm that alerts one or more users to the detected leak using signals other than audio signals.

Alarm device 152 may activate in response to receiving an alarm signal from leak detection and alarm control circuitry 150. In some examples, alarm device 152 may remain in a continuously activated state during a period of time in which alarm device 152 receives the alarm signal from leak detection and alarm control circuitry 150. In some examples, alarm device 152 may intermittently activate on a continuous basis during a period of time in which alarm device 152 receives the alarm signal indicating the leak in the water heater. For example, Alarm device 152 may activate according to a sequence of on/off cycles, where alarm device 152 alternates between an ‘on’ phase and an ‘off’ phase.

Pilot ignition circuitry 160 may include circuitry capable of generating one or more sparks to ignite intermittent pilot light 162. Additionally, or alternatively, pilot ignition circuitry 160 may control one or more valves that regulate a flow of gas to intermittent pilot light 162. For example, pilot ignition circuitry 160 may open one or more valves, allowing gas to flow to intermittent pilot light 162. Pilot ignition circuitry 160 may, in some cases, close one or more valves in order to cut off a gas supply to intermittent pilot light 162, extinguishing intermittent pilot light 162. In some examples, controller 122 of circuit 120 is configured to control pilot ignition circuitry 160 to ignite and/or extinguish intermittent pilot light 162.

In some examples, controller 122 is configured to control a main burner (not illustrated in FIG. 1) to maintain a temperature of water in a water heater tank at a predetermined temperature. In some examples, controller 122 may control intermittent pilot light 162 and/or the main burner in order to maintain the temperature of the water in the water heater tank. For example, to ignite the main burner, the controller 122 may control pilot ignition circuitry 160 to cause one or more valves to allow gas to flow to the intermittent pilot light 162, and controller 122 may control pilot ignition circuitry 160 to generate one or more sparks that ignite the gas flowing to intermittent pilot light 162. Controller 122 may additionally or alternatively cause one or more valves to open, allowing gas to flow to the main burner, and the ignited intermittent pilot light 162 may ignite the main burner. Controller 122 may extinguish one or both of the intermittent pilot light 162 and the main burner by closing one or more valves to cut off gas supply to the respective burner. Controller 122 may be configured to ignite, based on a water temperature model, intermittent pilot light 162 in order to toggle the main burner between an activated state and a deactivated state.

Although system 100 of FIG. 1 is described as including an intermittent pilot light 162, this is not required. In some examples, a system may include a standing pilot light (e.g., a pilot light which is continuously ignited) which causes thermoelectric device 112 to supply power to the circuit 120.

In some examples, water heater control system 100 may include a user interface (e.g., a knob). In some examples, to turn on the water heater control system 100, a user may turn the knob to a pilot position, press the knob down, and hold down a pilot button. The user may press a pilot button until the intermittent pilot light 162 is lit. In some examples, a user may check the sparks produced through a class window when the pilot button is pressed. In some examples, controller 122 may turn on whenever the water heater shuts down due to gas shortage. Water heater control system 100 may improve a convenience of turning on controller 122 and improve a gas efficiency of water heater control system 100 as compared with systems that do not use power converters to supply energy to a controller from one or more energy sources. Water heater control system 100 may include a number of functions including leak detection, alarm control, and damper control functions.

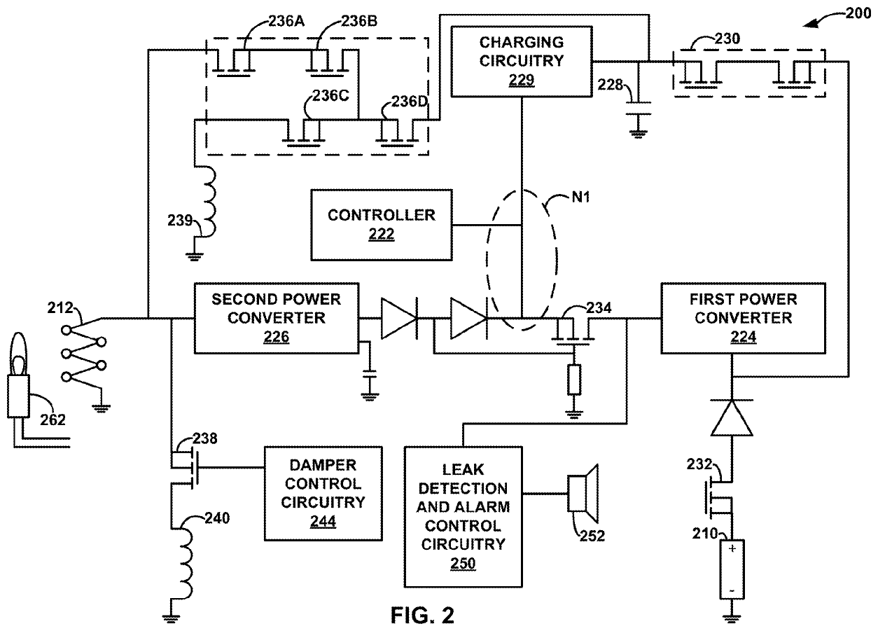

FIG. 2 is a block diagram illustrating a water heater control system 200 including a first one or more circuit elements, in accordance with one or more techniques of this disclosure. As illustrated in FIG. 2, system 200 includes pre-charged power source 210, thermoelectric device 212, controller 222, first power converter 224, second power converter 226, supercapacitor 228, and charging circuitry 229. System 200 includes switching devices 230-238, pilot valve element 239, damper motor element 240, damper control circuitry 244, leak detection and alarm control circuitry 250, alarm device 252, and intermittent pilot light 262.

Water heater control system 200 may be an example of water heater control system 100 of FIG. 1. Pre-charged power source 210 may be an example of pre-charged power source 110 of FIG. 1. Thermoelectric device 212 may be an example of thermoelectric device 112 of FIG. 1. Controller 222 may be an example of controller 122 of FIG. 1. First power converter 224 may be an example of first power converter 124 of FIG. 1 Second power converter 226 may be an example of second power converter 126 of FIG. 1. Supercapacitor 228 may be an example of supercapacitor 128 of FIG. 1. Leak detection and alarm control circuitry 240 may be an example of leak detection and alarm control circuitry 150 of FIG. 1. Alarm device 252 may be an example of alarm device 152 of FIG. 1.

Pre-charged power source 210 may, in some examples, supply power to first power converter 224 via switching device 232. In some examples, pre-charged power source 210 comprises one or more batteries (e.g., AA batteries, AAA batteries, D batteries, 9V batteries) and circuitry for connecting the one or more batteries to water heater control system 200. For example, one or more batteries of pre-charged power source 210 may fit within a battery housing that connects to one or more electrodes of the batteries so that the one or more batteries can deliver power to water heater control system 200.

Thermoelectric device 212 may, in some examples, be located proximate to a heat source (e.g., intermittent pilot light 262) so that thermoelectric device 212 converts heat energy into electrical energy. For example, thermoelectric device 212 may deliver an electrical signal to second power converter 226. Both thermoelectric device 212 and pre-charged power source 210 are configured to deliver electrical energy to water heater control system 200, with pre-charged power source 210 delivering electrical energy to first power converter 224. Water heater control system 200 may allocate electrical energy to one or more components within water heater control system 200 according to one or more techniques described herein.

Controller 222, in some examples, may include one or more processors (e.g., processing circuitry) that are configured to implement functionality and/or process instructions for execution within water heater control system 200. For example, controller 222 may be capable of processing instructions stored in a memory. Controller 222 may include, for example, microprocessors, DSPs, ASICs, FPGAs, or equivalent discrete or integrated logic circuitry, or a combination of any of the foregoing devices or circuitry.

Accordingly, controller 222 may include any suitable structure, whether in hardware, software, firmware, or any combination thereof, to perform the functions ascribed herein to controller 222.

Controller 222 may, in some examples, control water heater control system 200 to perform one or more operations. For example, controller 222 may control whether intermittent pilot light 262 and/or a main burner (not illustrated in FIG. 2) are ignited or extinguished in order to maintain water within a water heater tank at a predetermined temperature. Additionally, or alternatively, controller 222 may control damper control circuitry 244 to regulate a damper of the water heater control system 200 and control leak detection and alarm control circuitry 250, but this is not required. Damper control circuitry 244 and leak detection and alarm control circuitry 250 may, in some examples, perform one or more operations without input from controller 222.

Since controller 222 continuously controls whether the intermittent pilot light 262 and the main burner are ignited or extinguished, controller 222 may require a steady supply of electrical energy to perform one or more operations. In some examples, pre-charged power source 210 may supply electrical energy to controller 222 via first power converter 224. But it may be beneficial for controller 222 to draw energy from sources other than pre-charged power source 210 in order to extend a longevity of pre-charged power source 210. For example, controller 222 may be configured to receive electrical energy from thermoelectric device 212 via second power converter 226 and/or receive electrical energy from supercapacitor 228 via first power converter 224.

In some cases, first power converter 224 includes a DC-to-DC power converter, but this is not required. First power converter 224 may additionally or alternatively include any other kind of power converter (e.g., an AC-to-DC power converter). In some examples, first power converter 224 represents a boost converter that increases a voltage of a received electrical signal and decreases a current of the received electrical signal. First power converter 224 is not limited to being a boost converter. In some examples, first power converter 224 may include a buck converter, a buck-boost converter, or another kind of power converter.

In some examples, first power converter 224 may regulate an output electrical signal such that the electrical signal output from first power converter 224 comprises a substantially constant predetermined output voltage. The “substantially constant” predetermined output voltage may comprise a target voltage value that the first power converter 224 outputs. The output voltage may occasionally stray from the target voltage value, but the power converter 224 may maintain the output voltage at approximately the target voltage value. In some examples, the target voltage value for the electrical signal output from the first power converter 224 may be 3V, but this is not required. The target voltage value may include any voltage (e.g., 5V, 9V, or any other predetermined voltage value.

In some cases, second power converter 226 includes a DC-to-DC power converter, but this is not required. Second power converter 226 may additionally or alternatively include any other kind of power converter (e.g., an AC-to-DC power converter). In some examples, second power converter 226 represents a boost converter that increases a voltage of a received electrical signal and decreases a current of the received electrical signal.

In some examples, second power converter 226 may regulate an output electrical signal such that the electrical signal output from second power converter 226 comprises a substantially constant predetermined output voltage. The “substantially constant” predetermined output voltage may comprise a target voltage value that the second power converter 226 outputs. The output voltage may occasionally stray from the target voltage value, but the second power converter 226 may maintain the output voltage at approximately the target voltage value. In some examples, the target voltage value for the electrical signal output from the second power converter 226 may be 3V, but this is not required. The target voltage value may include any voltage (e.g., 5V, 9V, or any other predetermined voltage value.

In some examples, the target voltage value for the electrical signal output from first power converter 224 and the target voltage value output for the electrical signal output from second power converter 226 are the same voltage value such that both of the first power converter 224 and the second power converter 226 supply the same voltage to controller 222 and/or one or more other components. It may be beneficial for controller 222 to receive electrical energy at a steady predetermined voltage that is sufficient for performing one or more operations.

Supercapacitor 228 may include a capacitor that configured to store electrical energy and deliver electrical energy. When supercapacitor 228 receives an output electrical signal from charging circuitry 229, supercapacitor 228 may charge and store electrical energy. When supercapacitor 228 is charged above a minimum threshold level of energy, supercapacitor 228 may deliver energy to one or more components of water heater control system 200. When supercapacitor 228 discharges, supercapacitor 228 may release at least some of the electrical energy stored by supercapacitor 228 to one or more components of water heater control system 200. In some examples, supercapacitor 228 may charge when supercapacitor 228 receives an output voltage from thermoelectric device 212 via second power converter 226. When supercapacitor 228 discharges, supercapacitor 228 delivers electrical energy to one or more components of water heater control system 200 (e.g., controller 222) via first power converter 224.

Charging circuitry 229 may, in some examples, receive electrical energy from thermoelectric device 212 via second power converter 226 and deliver electrical energy to charge supercapacitor 228. In some examples, charging circuitry 229 may receive the same output voltage that controller 222 receives from second power converter 226 when intermittent pilot light 262 is ignited and when thermoelectric device 212 delivers electrical energy to second power converter 226. In some examples, charging circuitry 229 may receive electrical energy from pre-charged power source 210 via first power converter 224, and charging circuitry delivers electrical energy to charge supercapacitor 228.

In some examples, first power converter 224, second power converter 226, charging circuitry 229, and controller 222 are connected to the same node N1. In some examples, node N1 may also be referred to herein as a “common bus.” In some examples, circuitry connected to node N1 may receive the voltage that node NI occupies at any given time. For example, when node N1 has a voltage of 3V, controller 222 and charging circuitry 229 may both receive the voltage of 3V. In some examples, first power converter 224 and second power converter 226 may be configured to output substantially the same voltage such that node NI occupies substantially the same voltage regardless of whether first power converter 224 is supplying voltage to node N1, second power converter 226 is supplying voltage to node N1, or both of first power converter 224 and second power converter 226 are supplying voltage to node N1.

In some examples, one or more accessory circuits may be connected to node N1. For example, damper control circuitry 244 and leak detection and alarm control circuitry 250 may receive the voltage of node N1.

Each of switching devices 230-238 may, in some cases, include a power switch such as, but not limited to, any type of field-effect transistor (FET) including any combination of a metal-oxide-semiconductor field-effect transistor (MOSFET), a bipolar junction transistors (BJT), an insulated-gate bipolar transistor (IGBT), a junction field effect transistors (JFET), a high electron mobility transistor (HEMT), or other elements that use voltage and/or current for control. Additionally, or alternatively, each of switching devices 230-238 may include one or more n-type transistors, p-type transistors, and power transistors, or any combination thereof. In some examples, each of switching devices 230-238 includes one or more vertical transistors, lateral transistors, and/or horizontal transistors. In some examples, each of switching devices 230-238 may include other analog devices such as diodes and/or thyristors.

In some examples, each of switching devices 230-238 includes three terminals: two load terminals and a control terminal. MOSFETs may include a drain terminal, a source terminal, and at least one gate terminal, where the control terminal is a gate terminal. For BJTs, the control terminal may be a base terminal. Current may flow between the two load terminals of a switch, based on the voltage at the respective control terminal. Therefore, electrical current may flow across each of switching devices 230-238 based on control signals delivered to the control terminal of the respective switching device. In one example, if a voltage applied to the control terminal of one of switching devices 230-238 is greater than or equal to a voltage threshold, the respective switching device turns on, allowing the switching device to conduct electricity. Furthermore, the switching device may turn off when the voltage applied to the control terminal of the switching device is below the threshold voltage, thus preventing the switching device from conducting electricity.

Each of switching devices 230-238 may include various material compounds, such as Silicon, Silicon Carbide, Gallium Nitride, or any other combination of one or more semiconductor materials. In some examples, silicon carbide switches may experience lower switching power losses. Improvements in magnetics and faster switching, such as Gallium Nitride switches, may allow a switching device to draw short bursts of current. These higher frequency switching devices may require control signals to be sent with more precise timing, as compared to lower frequency switching devices.

One or more switching devices 230 may control whether an electrical connection exists between first power converter 224 and charging circuitry 229. A switching device 232 controls whether an electrical connection exists between pre-charged power source 210 and first power converter 224. Switching device 234 controls whether an electrical connection exists between first power converter 224 and controller 222 and whether an electrical connection exists between first power converter 224 and charging circuitry 229. Switching devices 236A-236D may control one or more electrical connections to a gas valve of intermittent pilot light 262. A switching device 238 may control one or more electrical connections to damper circuitry.

In some examples, water heater control system 200 includes a pilot valve element 239. Water heater control system 200 may control, by sending one or more electrical signals via the pilot valve element 239, whether a gas valve for the intermittent pilot light 262 is open or closed. When the gas valve for the intermittent pilot light 262 is open, intermittent pilot light 262 may be ignited by one or more sparks. When the gas valve for the intermittent pilot light 262 is closed, intermittent pilot light 262 may remain extinguished. When intermittent pilot light 262 is ignited, pilot valve element 239 may receive an electrical signal from thermoelectric device 212 via switching device 236A, switching device 236B, and switching device 236C. In some examples, switching device 236D may be turned off when the thermoelectric device 212 is ignited, disconnecting pilot valve element 239 from supercapacitor 228. When intermittent pilot light 262 is extinguished, pilot valve element 239 may receive an electrical signal from supercapacitor 228 via switching device 236D and switching device 236C. In some examples, switching device 236C and switching device 236D may be turned on when thermoelectric device 212 is extinguished, connecting supercapacitor 228 to pilot valve element 239.

In some examples, water heater control system 200 includes a damper motor element 240 and damper control circuitry 244. Damper control circuitry 244 may, in some examples, control whether a damper is open or closed by sending one or more electrical signals via damper motor element 240.

Leak detection and alarm control circuitry 250 may detect one or more leaks in a water heater tank. In some examples, leak detection and alarm control circuitry 250 may activate an alarm device 252 based on detecting the leak in the water heater tank. In some examples, when the alarm device 252 is deactivated, and the leak detection and alarm control circuity 250 is monitoring for leaks, leak detection and alarm control circuitry 250 may receive electrical energy from supercapacitor 228 via first power converter 224. When alarm device 252 is activated, leak detection and alarm control circuitry 250 and alarm device 252 may receive electrical energy from pre-charged power source 210 via first power converter 224.

In some examples, water heater control system 200 increases a longevity of pre-charged power source 210 to 5 years or more by reducing the leakage current from pre-charged power source 210 as compared with systems that do not draw power from a thermoelectric device proximate to a pilot light. Additionally, or alternatively, water heater control system 200 may deliver power to controller 222 from supercapacitor 228 in many cases rather than drawing power from pre-charged power source 210, thus increasing a longevity of pre-charged power source 210 as compared with systems that do not use a supercapacitor to power a controller. Water heater control system 210 may consume a smaller amount of gas than a traditional atmospheric water heater controller.

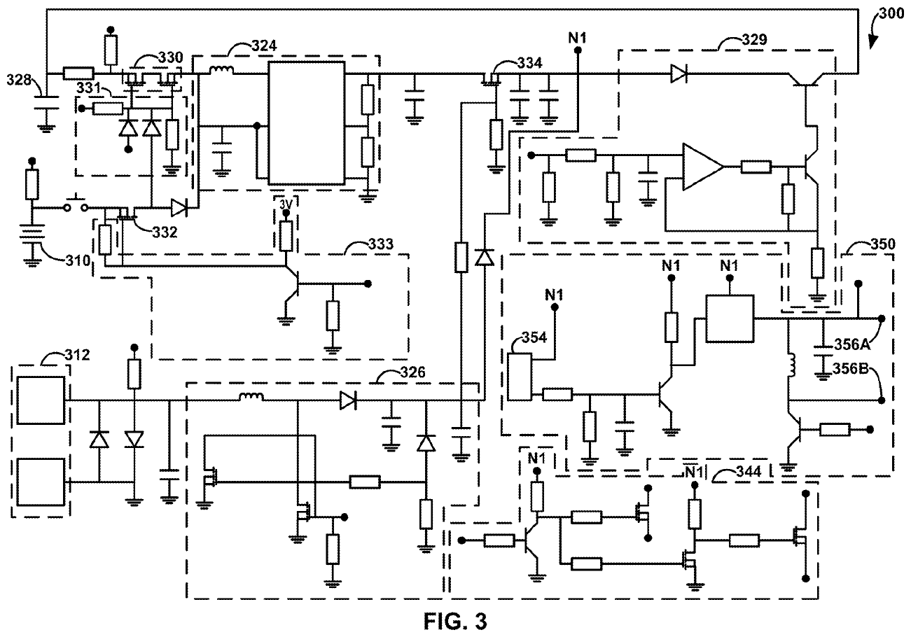

FIG. 3 is a block diagram illustrating a water heater control system 300 including a second one or more circuit elements, in accordance with one or more techniques of this disclosure. As illustrated in FIG. 3, system 300 includes pre-charged power source 310, thermoelectric device 312, first power converter 324, second power converter 326, supercapacitor 328, and charging circuitry 329. System 200 includes switching devices 330, 332, 334, damper control circuitry 344, and leak detection and alarm control circuitry 350.

Water heater control system 300 may be an example of water heater control system 100 of FIG. 1. Pre-charged energy source 310 may be an example of pre-charged energy source 110 of FIG. 1. Thermoelectric device 312 may be an example of thermoelectric device 112 of FIG. 1. First power converter 324 may be an example of first power converter 124 of FIG. 1 Second power converter 326 may be an example of second power converter 126 of FIG. 1. Supercapacitor 328 may be an example of supercapacitor 128 of FIG. 1. Leak detection and alarm control circuitry 350 may be an example of leak detection and alarm control circuitry 150 of FIG. 1. In some examples, water heater control system 300 may be an example of water heater control system 200 of FIG. 2, FIG. 2 may illustrate one or more elements not illustrated in FIG. 3, and FIG. 3 may illustrate one or more elements not illustrated in FIG. 2.

Pre-charged power source 310 may, in some examples, supply power to first power converter 324 via switching device 332. In some examples, pre-charged power source 310 comprises one or more batteries (e.g., AA batteries, AAA batteries, D batteries, 9V batteries) and circuitry for connecting the one or more batteries to water heater control system 300. Switching device control circuitry 333 may deliver one or more signals to switching device 332 that control whether switching device 332 is turned on or turned off. When switching device 332 is turned on, pre-charged power source 310 may deliver electrical energy to first power converter 324 via switching device 332. When switching device 332 is turned off, pre-charged power source 310 may be disconnected from first power converter 324 such that pre-charged power source 310 does not deliver electrical energy to first power converter 324. First power converter 324 may generate a predetermined voltage (e.g., 3V) using one or both of pre-charged power source 310 and supercapacitor 318.

Thermoelectric device 312 may, in some examples, be located proximate to a heat source (e.g., an intermittent pilot light) so that thermoelectric device 312 converts heat energy into electrical energy. For example, when an intermittent pilot light proximate to thermoelectric device 312 is ignited, thermoelectric device 312 is configured to generate an electrical signal for delivery to second power converter 326. When an intermittent pilot light proximate to thermoelectric device 312 is not ignited, thermoelectric device 312 might not deliver an electrical signal to second power converter 326, or thermoelectric device 312 might deliver an electrical signal to second power converter 326 with a voltage that is less than the voltage of the electrical signal delivered to second power converter 326 when the intermittent pilot light is activated.

When an intermittent pilot light proximate to thermoelectric device 312 is ignited, thermoelectric device 312 may supply electrical energy to a controller (e.g., controller 222 of FIG. 2) and supply electrical energy to charging circuitry 329 via second power converter 326. In some examples, the controller is connected to node N1 of FIG. 3. Charging circuitry 329 may deliver electrical energy to supercapacitor 328 in order to charge supercapacitor 328. In some examples, second power converter 326 may simultaneously deliver electrical energy to a controller and deliver electrical energy to charging circuitry 329 when the intermittent pilot light proximate to thermoelectric device 312 is ignited. In some examples, when second power converter 326 simultaneously delivers electrical energy to controller 322 and delivers electrical energy to charging circuitry 329, switching devices 330 and switching device 334 may be turned off. When switching devices 330 and switching device 334 are turned off, supercapacitor might not deliver electrical energy to the controller connected to node N1 via switching devices 330, second power converter 326, and switching device 334. In some examples, charging circuitry 329 comprises a current charging circuit including an operational amplifier and a transistor and that charges supercapacitor 328. In some examples, a charging current delivered to supercapacitor 328 depends on an operation of the transistor, a pulse-width modulation (PWM) signal duty cycle, and a transistor emitter resistance.

When an intermittent pilot light proximate to thermoelectric device 312 is not ignited, supercapacitor 328 may deliver electrical energy to the controller connected to node N1 via switching devices 330, first power converter 324, and switching device 334. In some examples, switching device control circuitry 331 controls whether switching devices 330 are turned on or turned off. In some examples, switching device control circuitry 331 may turn switching devices 330 on when supercapacitor 328 stores more than a threshold amount of energy, and when the intermittent pilot light proximate to thermoelectric device 312 is extinguished so that supercapacitor 328 may deliver electrical energy via switching devices. Additionally, or alternatively, when second power converter 326 receives less than a threshold voltage from thermoelectric device 312, switching device 334 may turn on so that supercapacitor 328 and/or pre-charged power source 310 may deliver electrical energy to the controller connected to node N1 via first power converter 324 and switching device 334.

When switching device 332 is turned on, pre-charged power source 310 may be connected to supercapacitor through switching devices 330 when switching devices 330 are turned on. Current flowing from pre-charged power source 310 to supercapacitor 228 across switching devices 330 may damage switching devices 330. When switching device 332 is turned on, current from pre-charged power source 310 may flow through switching device control circuitry 331 to turn off switching devices 330. When switching devices 330 are turned off, pre-charged power source 310 may deliver electrical energy to first power converter 324 via switching device 332.

In some examples, pre-charged power source 310 may provide electrical energy to the controller connected to node NI when the amount of energy stored by supercapacitor 328 is less than the threshold amount of energy, and when the intermittent pilot light proximate to thermoelectric device 312 is extinguished. But it may be beneficial for the controller to receive energy from supercapacitor 328 instead of receiving energy from pre-charged power source 310 to maintain a level of energy stored by pre-charged power source 310. In some examples, water heater control system 300 may control pilot ignition circuitry (not illustrated in FIG. 3) to ignite the intermittent pilot light when the amount of energy stored by supercapacitor 328 is less than the threshold amount of energy and when the intermittent pilot light proximate to thermoelectric device 312 is extinguished so that the thermoelectric device 312 may supply energy to the controller via the second power converter 326. By igniting the intermittent pilot light, water heater control system 300 may preserve a level of charge stored by pre-charged power source 310 by activating thermoelectric device 312 as an alternative power source to pre-charged power source 310.

When thermoelectric device 312 delivers electrical energy to the controller connected to node NI via second power converter 326, thermoelectric device 312 may in some examples simultaneously deliver electrical energy to supercapacitor 328 and a controller. By charging supercapacitor 328 while thermoelectric device 312 is simultaneously providing electrical energy to the controller via second power converter 326, water heater control system 300 may prepare supercapacitor 328 to provide electrical energy to the controller when the intermittent pilot light is extinguished and the thermoelectric device 312 does not output electrical energy sufficient for providing electrical energy to the controller. Since water heater control system 300 allows for both of the thermoelectric device 312 and the supercapacitor 328 to provide electrical energy to the controller, water heater control system 300 may extend a longevity of pre-charged power source 310 as compared with systems that do not allow for both of a thermoelectric device and a supercapacitor to provide electrical energy to a controller.

Damper control circuitry 344 may be configured to control a damper of water heater control system 300. In some examples, Damper control circuitry 344 may be connected to node N1 of FIG. 1. Damper control circuitry 344 may receive electrical energy from pre-charged power source 310, thermoelectric device 312, supercapacitor 328, or any combination thereof depending on which power sources supply electrical energy to node N1 via first power converter 324 and second power converter 326. Damper control circuitry 344 includes three switching devices (e.g., MOSFETs) and one transistor device. In some examples, damper control circuitry 344 opens and/or closes a damper using electrical energy received from thermoelectric device 312. In some examples, damper control circuitry 344 may operate using electrical energy received from one or both of first power converter 324 and second power converter 326 via node N1. Damper control circuitry 344 may monitor whether the damper is opened or closed by monitoring the damper voltage.

Leak detection and alarm control circuitry 350 may include a leak detector 354 and connections 356A-356B (collectively, “connectors 356”) for connecting alarm control circuitry 350 to an alarm device (not illustrated in FIG. 3). In some examples, leak detector 354 may be configured to detect a leak in a water heater tank and generate an alarm signal in response to detecting the leak in the water heater tank. Leak detector 354 may be connected to node N1 of FIG. 3. Leak detector 354 may receive electrical energy from pre-charged power source 310, thermoelectric device 312, supercapacitor 328, or any combination thereof depending on which power sources supply electrical energy to node NI via first power converter 324 and second power converter 326. Water heater control system 300 may control thermoelectric device 312 and/or supercapacitor 328 to provide electrical energy to node NI whenever the intermittent pilot light is turned on and whenever the supercapacitor 328 stores greater than a threshold amount of energy so that a level of charge stored by pre-charged power source 310 is not depleted.

Leak detection and alarm control circuitry 350 may include a resonant drive circuit comprising an inductor and a capacitor. In some examples, water heater control system 300 may drive leak detection and alarm control circuitry 350 this circuit with a PWM signal. Leak detection and alarm control circuitry 350 may output a piezoelectric resonant frequency and operating voltage to connectors 356, activating an alarm device. When leak detector 354 touches water, the transistor turns on, the resonant drive circuit is driven by the PWM signal, and leak detection and alarm control circuitry 350 may control an alarm device (e.g., a piezoelectric alarm device) to activate.

When leak detector 354 outputs an alarm signal indicating that a leak is detected in the water heater tank, the alarm signal may cause an alarm device connected to connectors 356 to connect to node NI and receive electrical energy. When the alarm device is connected to node N1, the alarm device may receive electrical energy and activate. In some examples, when the alarm device is activated by connecting alarm device to node N1 via connectors 356, the water heater control system 300 may cause pre-charged power source 310 to supply electrical energy to node NI via switching device 332, first power converter 324, and switching device 334. In some cases, the alarm device requires a greater amount of power than one or more other components of water heater control system 300, so the pre-charged power source 310 is used to power the alarm device. In some cases, one or both of the thermoelectric device 312 and the supercapacitor 328 supply power to the alarm device for a short time.

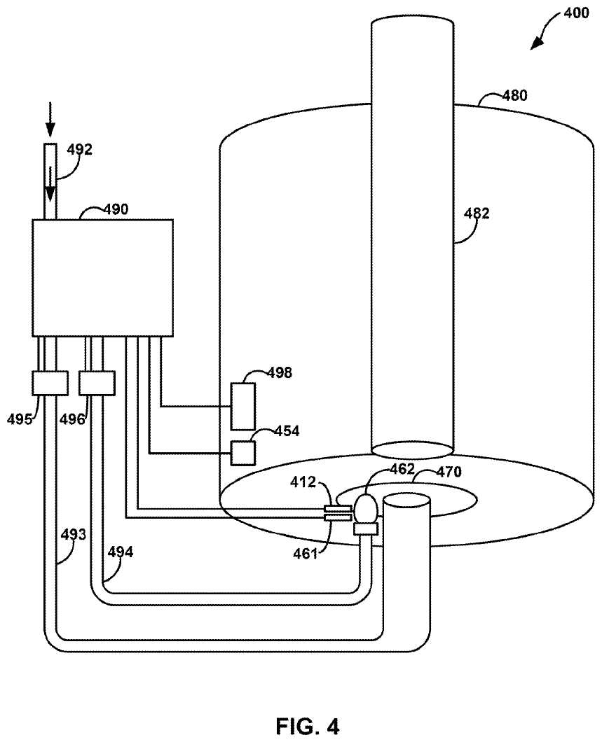

FIG. 4 provides an example water heater system 400 including intermittent pilot light 462 and main burner 470, in accordance with one or more techniques of this disclosure. As seen in FIG. 4, water heater system 400 includes thermoelectric device 412, leak detector 454, pilot ignition device 461, intermittent pilot light 462, main burner 470, water heater tank 480, flue 482, water heater control unit 490, fuel line 492, main burner fuel line 493, pilot fuel line 494, main burner fuel valve 495, pilot fuel valve 496, and temperature sensing device 498.

Water heater system 400 may include one or more components of water heater control system 100 of FIG. 1, water heater control system 200 of FIG. 2, water heater control system 300 of FIG. 3, or any combination thereof. For example, thermoelectric device 412 may be an example of thermoelectric device 112 of FIG. 1. Leak detector 454 may be an example of leak detector 354 of FIG. 3. Pilot ignition device 461 may be part of pilot ignition circuitry 160 of FIG. 1. Intermittent pilot light 462 may be an example of intermittent pilot light 162 of FIG. 1. Water heater control unit 490 may include one or more components that are present in water heater control system 100 of FIG. 1, water heater control system 200 of FIG. 2, water heater control system 300 of FIG. 3, or any combination thereof.

Water heater control unit 490 may control a temperature of water within water heater tank by controlling whether intermittent pilot light 462 and main burner 470 are ignited or extinguished. For example, fuel line 492 may deliver fuel to main burner fuel line 493 and pilot fuel line 494 via water heater control unit 490 Main burner fuel valve 495 may control whether fuel flows to main burner 470. When main burner fuel valve 495 is open, fuel may flow to main burner 470. When main burner fuel valve 495 is closed, main burner fuel valve 495 prevents fuel from flowing to main burner 470. In some examples, water heater control unit 490 may control whether main burner fuel valve 495 is open or closed, thus controlling whether main burner 470 receives fuel. Additionally, or alternatively, pilot fuel valve 496 may control whether fuel flows to intermittent pilot light 462. When pilot fuel valve 496 is open, fuel may flow to intermittent pilot light 462. When pilot fuel valve 496 is closed, pilot fuel valve 496 prevents fuel from flowing to intermittent pilot light 462. In some examples, water heater control unit 490 may control whether pilot fuel valve 496 is open or closed, thus controlling whether intermittent pilot light 462 receives fuel.

Water heater control unit 490 may control whether intermittent pilot light 462 and main burner 470 are ignited or extinguished by controlling main burner fuel valve 495, pilot fuel valve 496, and pilot ignition device 461. For example, when intermittent pilot light 462 and main burner 470 are both extinguished, water heater control unit 490 may open pilot fuel valve 496, allowing fuel to flow to intermittent pilot light 462. Water heater control unit 490 may control pilot ignition device 461 to emit one or more sparks, igniting the fuel flowing to intermittent pilot light 462 via pilot fuel line 494. Water heater control unit 490 may open main burner fuel valve 495, allowing fuel to flow to main burner 470. When intermittent pilot light 462 is ignited, the pilot flame may ignite the fuel flowing to main burner 470, thus igniting main burner 470. Water heater control unit 490 may, at any time extinguish one or both of intermittent pilot light 462 and main burner 470 by closing the respective fuel valve 495, 496. Flue 482 may be an exhaust for main burner 470 and/or intermittent pilot light 462.

Thermoelectric device 412 may be electrically connected to water heater control unit 490. As seen in FIG. 4, thermoelectric device 412 is located proximate to intermittent pilot light 462 such that thermoelectric device 412 may generate electrical energy when intermittent pilot light 462 is ignited. Thermoelectric device 412 may deliver electrical energy to water heater control unit 490. Thermoelectric device 412 may be in thermal communication with a pilot flame generated at intermittent pilot light 462 and may convert some portion of a heat flux emitted by the pilot flame into electrical energy. A temperature sensing device 498 may be connected to water heater control unit 490 and situated on water heater tank 480, or otherwise be configured to be in thermal communication with a volume of water in water heater tank 480. Water heater control unit 490 may include a controller configured to establish electrical or data communication with one or more of main burner fuel valve 495, the pilot fuel valve 496, and other components.

Water heater control unit 490 may include a pilot valve operator configured to actuate the pilot fuel valve 496 and may include a main valve operator configured to actuate main burner fuel valve 495. Water heater control unit 490 may, in some examples, establish an electrical connection between thermoelectric device 412 and the main valve operator, such that the main valve operator can be powered by thermoelectric device 412. In other examples, water heater control unit 490 uses other power sources to operate the main valve operator. Water heater control unit 490 may, in some examples, establish an electrical connection between thermoelectric device 412 and the pilot valve operator, such that the pilot valve operator can be powered by thermoelectric device 412. In other examples, water heater control unit 490 uses other power sources to operate the pilot valve operator. Water heater control unit 490 may, in some examples, include one or more energy storage devices (e.g., one or more supercapacitors and/or one or more charged energy sources) configured to provide power to one or more components of water heater system 400.

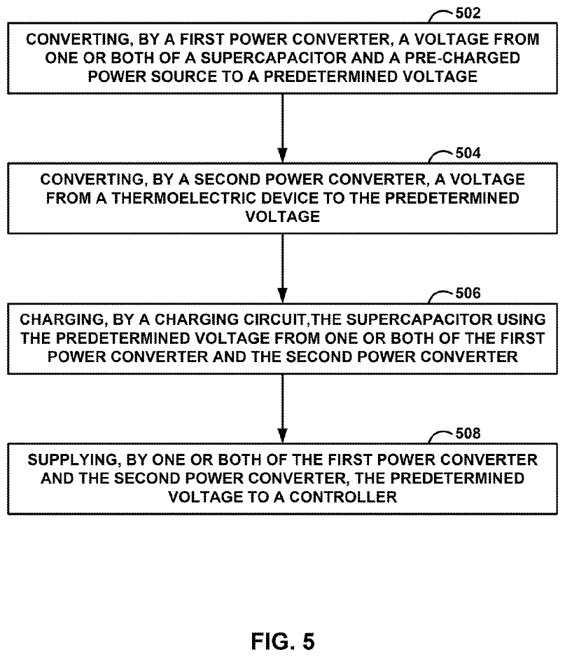

FIG. 5 is a flow diagram illustrating an example operation for delivering electrical energy to a supercapacitor and a controller, in accordance with one or more techniques of this disclosure. For convenience, FIG. 5 is described with respect to water heater control system 100 of FIG. 1. However, the techniques of FIG. 5 may be performed by different components of water heater control system 100, or by additional or alternative systems and devices.

First power converter 124 is configured to convert a voltage from one or both of a supercapacitor 128 and a pre-charged power source 110 (502). In some cases, first power converter 124 may receive an electrical signal from pre-charged power source 110 and convert the voltage from pre-charged power source 110 to the predetermined voltage. In some cases, first power converter 124 may receive an electrical signal from supercapacitor 128 and convert the voltage from supercapacitor 128 to the predetermined voltage. In some examples, first power converter 124 may comprise a DC-to-DC boost converter, but this is not required. First power converter 124 may comprise any kind of power converter.

Second power converter 126 is configured to convert a voltage from thermoelectric device 112 to the predetermined voltage (504). In some examples, the second power converter receives the voltage from thermoelectric device 112 when an intermittent pilot light 162 is ignited. In some examples, when intermittent pilot light 162 is not ignited, thermoelectric device 112 does not deliver the voltage to second power converter 126. In some examples, second power converter 126 is connected to the same common bus that first power converter 124 is connected to.

Charging circuitry may charge supercapacitor 128 using the predetermined voltage from one or both of the first power converter 124 and the second power converter 126 (506). In other words, any one or combination of the pre-charged power source 110 and the thermoelectric device 112 may supply electrical energy that power converters 124, 126 deliver to charge the supercapacitor 128. Additionally, or alternatively, one or both of the first power converter 124 and the second power converter 126 may supply the predetermined voltage to controller 122 (508).

The following numbered clauses may demonstrate one or more aspects of the disclosure.

Clause 1: A water heater pilot control system, comprising: a supercapacitor; a battery; a controller configured to control ignition of a flame; and voltage control circuitry comprising: a first power converter configured to convert a voltage from one or both of the supercapacitor and the battery to a predetermined voltage; a second power converter configured to convert a voltage from a thermoelectric device to the predetermined voltage; and charging circuitry configured to charge the supercapacitor using the predetermined voltage from one or both of the first power converter and the second power converter, wherein one or both of the first power converter and the second power converter are configured to supply the predetermined voltage to the controller.

Clause 2: The system of clause 1, wherein the voltage control circuitry comprises a common bus connected to the controller, the first power converter, the second power converter, and the charging circuit, wherein the common bus is configured to operate at the predetermined voltage, and wherein the pilot control system further comprises one or more accessory circuits coupled to the common bus.

Clause 3: The water heater pilot control system of clause 2, wherein the one or more accessory circuits comprise damper control circuitry configured to operate a damper of a water heater.

Clause 4: The water heater pilot control system of any of clauses 2-3, wherein the one or more accessory circuits comprise leak detection and alarm control circuitry configured to: detect a leak from a water heater tank; generate an alarm signal indicating the leak from the water heater tank; and output the alarm signal to activate an alarm device in response to detecting the leak.

Clause 5: The water heater pilot control system of any of clauses 2-4, wherein the first power converter is configured to: convert, when a switching device disconnects the battery from the first power converter, the voltage from the supercapacitor to the predetermined voltage; and supply the predetermined voltage to the common bus.

Clause 6: The water heater pilot control system of any of clauses 2-5, wherein the one or more accessory circuits comprise leak detection and alarm control circuitry configured to: detect a leak from a water heater tank; generate an alarm signal indicating the leak from the water heater tank; and output the alarm signal to activate an alarm device in response to detecting the leak, wherein the leak detection and alarm control circuitry is configured to activate, based on detecting the leak from the water heater, the switching device to connect the battery to the first power converter, and wherein the first power converter is configured to: receive the voltage from the battery; convert the voltage from the battery to the predetermined voltage; and supply the predetermined voltage to the alarm to initiate the alarm in response to detecting the leak.

Clause 7: The water heater pilot control system of any of clauses 1-6, further comprising pilot ignition circuitry configured to ignite the flame in response to receiving power from the battery, wherein the flame comprises a pilot flame of an intermittent pilot light.

Clause 8: The water heater pilot control system of any of clauses 1-7, wherein the second power converter is configured to: supply, when the thermoelectric device is ignited, the predetermined voltage to the controller; and supply, when the thermoelectric device is ignited, the predetermined voltage to the charging circuit.

Clause 9: The water heater pilot control system clause 8, wherein the charging circuitry is configured to charge, when the thermoelectric device is supplying the voltage, the supercapacitor using the predetermined voltage supplied by the second power converter without charging the supercapacitor using the voltage from the battery.

Clause 10: The water heater pilot control system of any of clauses 1-9, wherein the first power converter is configured to: receive, when the thermoelectric device is not ignited and when a switching device disconnects the battery from the first power converter, the voltage from the supercapacitor; convert, when the thermoelectric device is not ignited and when the switching device disconnects the battery from the first power converter, the voltage from the supercapacitor to the predetermined voltage; and supply the predetermined voltage to the controller.

Clause 11: A method comprising: controlling, by a controller, ignition of a flame; converting, by a first power converter of voltage control circuitry, a voltage from one or both of the supercapacitor and the battery to a predetermined voltage; converting, by a second power converter of the voltage control circuitry, a voltage from a thermoelectric device to the predetermined voltage; charging, by charging circuitry of the voltage control circuitry, the supercapacitor using the predetermined voltage from one or both of the first power converter and the second power converter; and supplying, by one or both of the first power converter and the second power converter, the predetermined voltage to the controller.

Clause 12: The method of clause 11, wherein the voltage control circuitry comprises a common bus connected to the controller, the first power converter, the second power converter, and the charging circuit, wherein the common bus is configured to operate at the predetermined voltage, and wherein the pilot control system further comprises one or more accessory circuits coupled to the common bus.

Clause 13: The method of clause 12, further comprising operating, by damper control circuitry of the one or more accessory circuits, a damper of a water heater.

Clause 14: The method of any of clauses 12-13, further comprising: detecting, by leak detection and alarm control circuitry of the one or more accessory circuits, a leak from a water heater tank; generating, by the leak detection and alarm control circuitry, an alarm signal indicating the leak from the water heater tank; and outputting, by the leak detection and alarm control circuitry, the alarm signal to activate an alarm device in response to detecting the leak.

Clause 15: The method of any of clauses 12-14, further comprising: converting, by the first power converter when a switching device disconnects the battery from the first power converter, the voltage from the supercapacitor to the predetermined voltage; and supplying, by the first power converter, the predetermined voltage to the common bus.

Clause 16: The method of any of clauses 12-15, further comprising: detecting, by leak detection and alarm control circuitry of the one or more accessory circuits, a leak from a water heater tank; generating, by the leak detection and alarm control circuitry, an alarm signal indicating the leak from the water heater tank; and outputting, by the leak detection and alarm control circuitry, the alarm signal to activate an alarm device in response to detecting the leak; activating, by the leak detection and alarm control circuitry and based on detecting the leak from the water heater, the switching device to connect the battery to the first power converter; receiving, by the first power converter, the voltage from the battery; converting, by the first power converter, the voltage from the battery to the predetermined voltage; and supplying, by the first power converter, the predetermined voltage to the alarm to initiate the alarm in response to detecting the leak.

Clause 17: The method of any of clauses 11-16, further comprising igniting, by pilot ignition circuitry, the flame in response to receiving power from the battery, wherein the flame comprises a pilot flame of an intermittent pilot light.

Clause 18: The method of any of clauses 11-17, further comprising: supplying, by the second power converter when the thermoelectric device is ignited, the predetermined voltage to the controller; and supplying, by the second power converter when the thermoelectric device is ignited, the predetermined voltage to the charging circuit.

Clause 19: The method of claim 18, further comprising charging, by the charging circuit when the thermoelectric device is supplying the voltage, the supercapacitor using the predetermined voltage supplied by the second power converter without charging the supercapacitor using the voltage from the battery.

Clause 20: A circuit comprising: a first power converter configured to convert a voltage from one or both of a supercapacitor and a pre-charged power source to a predetermined voltage; a second power converter configured to convert a voltage from a thermoelectric device to the predetermined voltage; and a charging circuit configured to charge the supercapacitor using the predetermined voltage from one or both of the first power converter and the second power converter, wherein one or both of the first power converter and the second power converter are configured to supply the predetermined voltage to a controller.

In one or more examples, the systems described herein may utilize hardware, software, firmware, or any combination thereof for achieving the functions described. Those functions implemented in software may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure.

Instructions may be executed by one or more processors within the system or communicatively coupled to the system. The one or more processors may, for example, include one or more DSPs, general purpose microprocessors, application specific integrated circuits ASICs, FPGAs, or other equivalent integrated or discrete logic circuitry. Accordingly, the term “processor,” as used herein may refer to any of the foregoing structure or any other structure suitable for implementation of the techniques described herein. In addition, in some respects, the functionality described herein may be provided within dedicated hardware and/or software modules configured for performing the techniques described herein. Also, the techniques could be fully implemented in one or more circuits or logic elements.

The techniques of this disclosure may be implemented in a wide variety of devices or apparatuses that include integrated circuits (ICs) or sets of ICs (e.g., chip sets). Various components, modules, or units are described in this disclosure to emphasize functional aspects of devices configured to perform the disclosed techniques, but do not necessarily require realization by different hardware units. Rather, various units may be combined or provided by a collection of interoperative hardware units, including one or more processors as described above, in conjunction with suitable software and/or firmware.

1. A water heater pilot control system, comprising:
a supercapacitor;
a battery;
a controller configured to control ignition of a flame; and
voltage control circuitry comprising:
a first power converter configured to convert a voltage from one or both of the supercapacitor and the battery to a predetermined voltage;
a second power converter configured to convert a voltage from a thermoelectric device to the predetermined voltage; and
charging circuitry configured to charge the supercapacitor using the predetermined voltage from one or both of the first power converter and the second power converter, wherein one or both of the first power converter and the second power converter are configured to supply the predetermined voltage to the controller.

2. The water heater pilot control system of claim 1, wherein the voltage control circuitry comprises a common bus connected to the controller, the first power converter, the second power converter, and the charging circuitry, wherein the common bus is configured to operate at the predetermined voltage, and wherein the water heater pilot control system further comprises one or more accessory circuits coupled to the common bus.

3. The water heater pilot control system of claim 2, wherein the one or more accessory circuits comprise damper control circuitry configured to operate a damper of a water heater.

4. The water heater pilot control system of claim 2, wherein the one or more accessory circuits comprise leak detection and alarm control circuitry configured to:
detect a leak from a water heater tank;
generate an alarm signal indicating the leak from the water heater tank; and
output the alarm signal to activate an alarm device in response to detecting the leak.

5. The water heater pilot control system of claim 2, wherein the first power converter is configured to:
convert, when a switching device disconnects the battery from the first power converter, the voltage from the supercapacitor to the predetermined voltage; and
supply the predetermined voltage to the common bus.

6. The water heater pilot control system of claim 5,
wherein the one or more accessory circuits comprise leak detection and alarm control circuitry configured to:
detect a leak from a water heater tank;
generate an alarm signal indicating the leak from the water heater tank; and
output the alarm signal to activate an alarm device in response to detecting the leak,
wherein the leak detection and alarm control circuitry is configured to activate, based on detecting the leak from the water heater tank, the switching device to connect the battery to the first power converter, and
wherein the first power converter is configured to:
receive the voltage from the battery;
convert the voltage from the battery to the predetermined voltage; and
supply the predetermined voltage to the alarm control circuitry to initiate the alarm signal in response to detecting the leak.

7. The water heater pilot control system of claim 1, further comprising pilot ignition circuitry configured to ignite the flame in response to receiving power from the battery, wherein the flame comprises a pilot flame of an intermittent pilot light.

8. The water heater pilot control system of claim 1, wherein the second power converter is configured to:
supply, when the thermoelectric device is ignited, the predetermined voltage to the controller; and
supply, when the thermoelectric device is ignited, the predetermined voltage to the charging circuitry.

9. The water heater pilot control system of claim 8, wherein the charging circuitry is configured to charge, when the thermoelectric device is supplying the voltage, the supercapacitor using the predetermined voltage supplied by the second power converter without charging the supercapacitor using the voltage from the battery.

10. The water heater pilot control system of claim 1, wherein the first power converter is configured to:
receive, when the thermoelectric device is not ignited and when a switching device disconnects the battery from the first power converter, the voltage from the supercapacitor;
convert, when the thermoelectric device is not ignited and when the switching device disconnects the battery from the first power converter, the voltage from the supercapacitor to the predetermined voltage; and
supply the predetermined voltage to the controller.

11. A method comprising:
controlling, by a controller, ignition of a flame;
converting, by a first power converter of voltage control circuitry, a voltage from one or both of a supercapacitor and a battery to a predetermined voltage;
converting, by a second power converter of the voltage control circuitry, a voltage from a thermoelectric device to the predetermined voltage;
charging, by charging circuitry of the voltage control circuitry, the supercapacitor using the predetermined voltage from one or both of the first power converter and the second power converter; and
supplying, by one or both of the first power converter and the second power converter, the predetermined voltage to the controller.

12. The method of claim 11, wherein the voltage control circuitry comprises a common bus connected to the controller, the first power converter, the second power converter, and the charging circuitry,
wherein the common bus is configured to operate at the predetermined voltage, and
wherein a water heater pilot control system further comprises one or more accessory circuits coupled to the common bus.

13. The method of claim 12, further comprising operating, by damper control circuitry of the one or more accessory circuits, a damper of a water heater.

14. The method of claim 12, further comprising:
detecting, by leak detection and alarm control circuitry of the one or more accessory circuits, a leak from a water heater tank;
generating, by the leak detection and alarm control circuitry, an alarm signal indicating the leak from the water heater tank; and
outputting, by the leak detection and alarm control circuitry, the alarm signal to activate an alarm device in response to detecting the leak.

15. The method of claim 12, further comprising:
converting, by the first power converter when a switching device disconnects the battery from the first power converter, the voltage from the supercapacitor to the predetermined voltage; and
supplying, by the first power converter, the predetermined voltage to the common bus.

16. The method of claim 15, further comprising:
detecting, by leak detection and alarm control circuitry of the one or more accessory circuits, a leak from a water heater tank;
generating, by the leak detection and alarm control circuitry, an alarm signal indicating the leak from the water heater tank; and
outputting, by the leak detection and alarm control circuitry, the alarm signal to activate an alarm device in response to detecting the leak;
activating, by the leak detection and alarm control circuitry and based on detecting the leak from the water heater tank, the switching device to connect the battery to the first power converter;
receiving, by the first power converter, the voltage from the battery;
converting, by the first power converter, the voltage from the battery to the predetermined voltage; and
supplying, by the first power converter, the predetermined voltage to the alarm circuitry to initiate the alarm signal in response to detecting the leak.

17. The method of claim 11, further comprising igniting, by pilot ignition circuitry, the flame in response to receiving power from the battery, wherein the flame comprises a pilot flame of an intermittent pilot light.

18. The method of claim 11, further comprising:
supplying, by the second power converter when the thermoelectric device is ignited, the predetermined voltage to the controller; and
supplying, by the second power converter when the thermoelectric device is ignited, the predetermined voltage to the charging circuitry.

19. The method of claim 18, further comprising charging, by the charging circuitry when the thermoelectric device is supplying the voltage, the supercapacitor using the predetermined voltage supplied by the second power converter without charging the supercapacitor using the voltage from the battery.

20. A circuit comprising:
a first power converter configured to convert a voltage from one or both of a supercapacitor and
a pre-charged power source to a predetermined voltage;
a second power converter configured to convert a voltage from a thermoelectric device to the predetermined voltage; and
a charging circuit configured to charge the supercapacitor using the predetermined voltage from one or both of the first power converter and the second power converter,
wherein one or both of the first power converter and the second power converter are configured to supply the predetermined voltage to a controller.
